(19) United States
(12) Patent Application Publication
(10) Pub. No.: US 2026/0012387 A1
(43) Pub. Date: Jan. 8, 2026

(54) ULTRA LOW POWER DIGITAL GLASS

(71) Applicant: QUALCOMM Incorporated, San Diego, CA (US)

(72) Inventors: Pratik DAS, Escondido, CA (US); Jian SHEN, San Diego, CA (US); Jerry YANG, San Diego, CA (US)

(21) Appl. No.: 18/764,080

(22) Filed: Jul. 3, 2024

(51) Int. Cl. H04L 41/0803; G02B 27/01; G06F 3/01; H04L 1/1607; H04L 65/60

(52) U.S. Cl. CPC H04L 41/0803; G02B 27/017; G06F 3/012; H04L 1/1657; H04L 65/60

(57) ABSTRACT

Aspects presented herein relate to methods and devices for wireless communication including an apparatus, e.g., client device or server. The apparatus may initialize a setup of a modem of the wireless device for a wireless connection with a user equipment (UE). The apparatus may also establish the wireless connection with the UE. The apparatus may also transmit, to the UE, a request for one or more of a header of at least one image or a set of image segments for the at least one image. The apparatus may also configure a set of components of the wireless device based on one or more of the header of the at least one image or the set of image segments for the at least one image.

### TECHNICAL FIELD

The present disclosure relates generally to processing systems and, more particularly, to one or more techniques for split rendering applications.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a client device, a server, a user equipment (UE), a display processing unit (DPU), a graphics processing unit (GPU), or any apparatus that may perform wireless communication. The apparatus may initialize a setup of a modem of the wireless device for a wireless connection with a user equipment (UE). The apparatus may also establish the wireless connection with the UE. Additionally, the apparatus may transmit, to the UE, a request for one or more of a header of at least one image or a set of image segments for the at least one image. The apparatus may also receive, from the UE, one or more of the header of the at least one image or the set of image segments for the at least one image. The apparatus may also store, in memory of the wireless device, one or more of the header of the at least one image or the set of image segments for the at least one image, where the memory of the wireless device is on-chip memory of the wireless device or static random access memory (SRAM) of the wireless device. The apparatus may also configure a set of components of the wireless device based on one or more of the header of the at least one image or the set of image segments for the at least one image. Moreover, the apparatus may initiate, based on the configuration of the set of components, a set of applications of the wireless device. The apparatus may also determine, based on the initiation of the set of applications, whether to wake-up, sleep, or power down the wireless device. The apparatus may also initiate, based on the determination, a sleep mode at the wireless device including a partial power down mode of the wireless device based on a set of partial state retention conditions. The apparatus may also initiate, based on the determination, a full power down at the wireless device based on at least one of: an event hysteresis, a user input motion, or a preset head motion. The apparatus may also output an indication of the configuration of the set of components of the wireless device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example communication of content/data in accordance with a split rendering process.

FIG. 5 is a diagram illustrating an example timeline of a split rendering process.

FIG. 6 is a diagram illustrating an example diagram of a split rendering process

FIG. 7 is a diagram illustrating an example flow diagram for a split rendering process

FIG. 8 is a diagram illustrating an example flow diagram for a split rendering process

FIG. 9 is a communication flow diagram illustrating example communications between a device, a user equipment (UE), and a memory.

FIG. 10 is a flowchart of an example method of wireless communication.

FIG. 11 is a flowchart of an example method of wireless communication.

FIG. 12 is a diagram illustrating an example of a hardware implementation for an example apparatus and/or network entity.

### DETAILED DESCRIPTION

Extended reality (XR), augmented reality (AR), and mixed reality (MR) applications typically use a viewing device for a user, such as a headset, a head-mounted device (HMD), and/or a glass). However, the use of headsets, head-mounted devices (HMDs), and/or glasses within extended reality (XR) has created a number of issues. For instance, headsets, HMDs and XR glasses may be expensive because they have extreme cutting escape abilities. These devices may also be power hungry, as they may include an external battery pack with a tether. Indeed, there are a lot of challenges for the use of XR, AR, and MR digital glasses, due to its smaller factor than UE and tougher power limit (e.g., chipset power is less than 500 mW). In a typical split XR architecture, the distributed processor may be divided between the XR glass and server (e.g., UE or cloud edge server). Also, the power consumption may be too high for demanding XR/AR/MR applications, due to involvement of local processing and long-range communication. Another approach is aggressively offloading from XR/AR/MR applications to a nearby server (e.g., UE or cloud edge server). This may convert an XR/AR/MR device to share all the local sensor with the server (e.g., UE or cloud edge server) without pro-processing. Additionally, this may obtain from the server or UE rendered videos without post-processing, such as over an ultra-wide band (UWB) connection. By doing so, there may be significant power reduction, but this still may not draw down the power consumption to an acceptable range (e.g., less than 1 to 3 W). There are also other types of XR/AR/MR glasses, such as a digital glass (DG), that is different from typical mixed reality (MR), augmented reality (AR), or virtual reality (VR) headsets. A digital glass may refer to low power glass, headset or head-mounted display (HMD) for use in XR/AR/MR applications. For instance, a digital glass (e.g., an AR/VR/MR digital glass) may be a power efficient lightweight, simple device that allows a notification (e.g., a heads-up notification) and has a number of key sensors. These types of devices may be utilized for a long amount of time, so they may need a long life from a small battery. Aspects of the present disclosure may reduce the amount of power consumption at low power devices or ultra-low power devices (e.g., a digital glass).

Aspects of the present disclosure may include a number of benefits or advantages. For instance, aspects presented herein may reduce the amount of power consumption at low power devices or ultra-low power devices (e.g., a digital glass). For instance, aspects presented herein may increase the amount of battery life at low power devices or ultra-low power devices (e.g., a digital glass). Also, aspects presented herein may reduce the amount of processing functions at low power devices or ultra-low power devices (e.g., a digital glass). In order to do so, aspects of the present disclosure adjust processing functions that, in turn, may reduce the power consumption for a low power devices or ultra-low power devices (e.g., a digital glass). For example, aspects presented herein may reduce the amount of key processing functions that are utilized at low power devices or ultra-low power devices (e.g., a digital glass). That is, aspects presented herein may offload certain processing functions to another device (e.g., a server or UE). By doing so, aspects presented herein may reduce the amount of processing functions, which in turn may reduce the amount of power consumption at low power devices (e.g., digital glass). For example, aspects presented herein may transfer processing functions to a server (e.g., a cloud server, an edge server, or a UE. Indeed, aspects presented herein may offload processing functions via a wireless personal network (WPN) to a companion device (e.g., a server or UE).

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

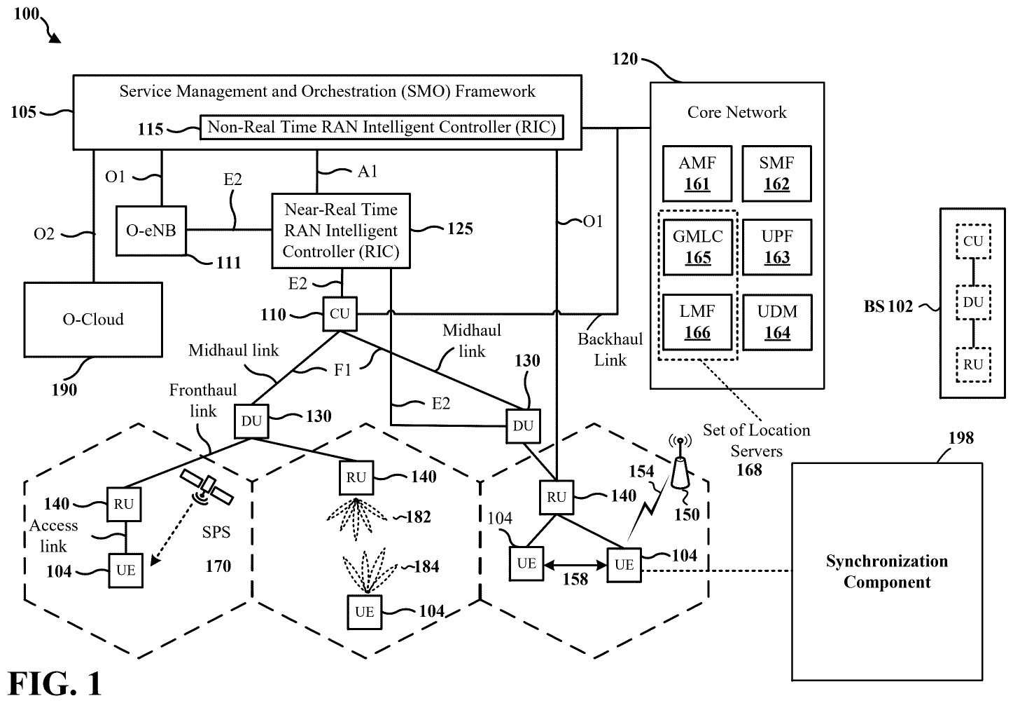

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHz) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a synchronization component 198 that may be configured to initialize a setup of a modem of the wireless device for a wireless connection with a user equipment (UE). Synchronization component 198 may also be configured to establish the wireless connection with the UE. Synchronization component 198 may also be configured to transmit, to the UE, a request for one or more of a header of at least one image or a set of image segments for the at least one image. Synchronization component 198 may also be configured to receive, from the UE, one or more of the header of the at least one image or the set of image segments for the at least one image. Synchronization component 198 may also be configured to store, in memory of the wireless device, one or more of the header of the at least one image or the set of image segments for the at least one image, where the memory of the wireless device is on-chip memory of the wireless device or static random access memory (SRAM) of the wireless device. Synchronization component 198 may also be configured to configure a set of components of the wireless device based on one or more of the header of the at least one image or the set of image segments for the at least one image. Synchronization component 198 may also be configured to initiate, based on the configuration of the set of components, a set of applications of the wireless device. Synchronization component 198 may also be configured to determine, based on the initiation of the set of applications, whether to wake-up, sleep, or power down the wireless device. Synchronization component 198 may also be configured to initiate, based on the determination, a sleep mode at the wireless device including a partial power down mode of the wireless device based on a set of partial state retention conditions. Synchronization component 198 may also be configured to initiate, based on the determination, a full power down at the wireless device based on at least one of: an event hysteresis, a user input motion, or a preset head motion. Synchronization component 198 may also be configured to output an indication of the configuration of the set of components of the wireless device.

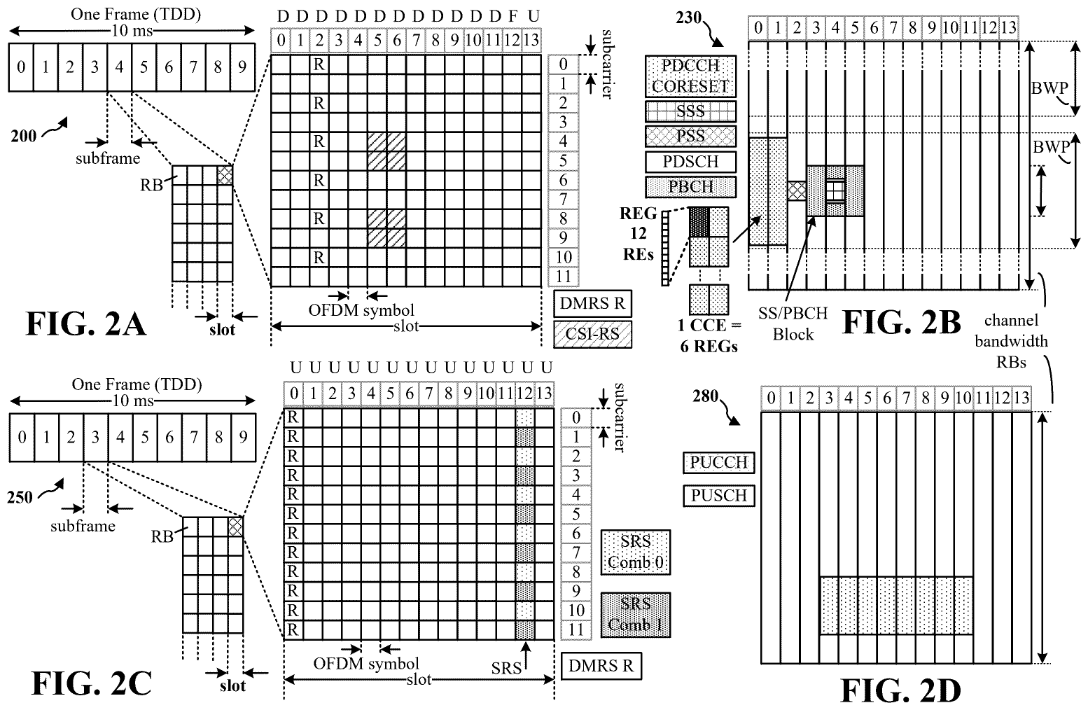

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

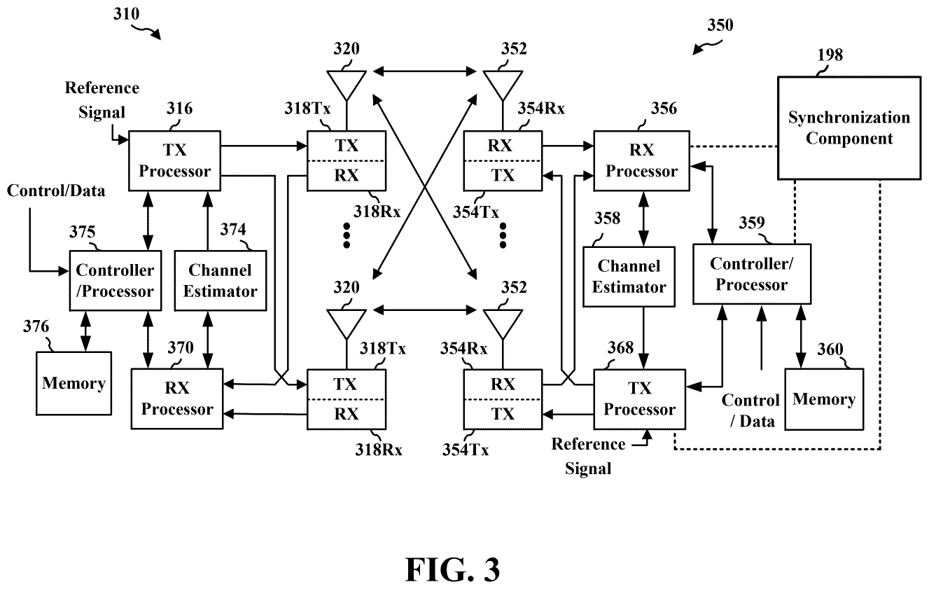

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the synchronization component 198 of FIG. 1.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

In some aspects, a display device may present frames at different frame rates on the first display panel and the second display panel. For instance, a display panel may present frames at 60 frames per second (FPS) on both the first display panel and the second display panel, 45 FPS on both the first display panel and the second display panel, etc. The display device may synchronize frame rates of content with refresh rates of the display panels (via a vertical synchronization process, which may be referred to as vsync, Vsync, VSync, or VSYNC). For instance, content may be available at 60 FPS and the first display panel and the second display panel may have a refresh rate of 95 Hz. Via Vsync, the refresh rate of the first display panel and the second display panel may be set to 60 Hz to match the 60 FPS content.

As indicated herein, VSync is a graphics technology that synchronizes the frame rate of an application/game with a refresh rate at a display (e.g., a display on a client device). Vsync may be utilized as a manner in which to deal with screen tearing (i.e., the screen displays portions of multiple frames at once). That can result in the display appearing to be split along a line. Tearing may occur when the display refresh rate (i.e., how many times the display updates per second) is not in synchronization with the frames per second (FPS). VSync signals may synchronize the display pipeline (e.g., the pipeline including application rendering, compositor, and a hardware composer (HWC) that presents images on the display). For instance, VSync signals may help to synchronize the time in which applications wake up to start rendering, the time the compositor wakes up to composite the screen, and the display refresh cycle. This synchronization may help to eliminate display refresh issues and improve visual performance. In some examples, the HWC may generates VSync events/signals and send the events/signals to the compositor.

In some aspects of graphics processing, the rendering of content may be performed in multiple locations and/or on multiple devices, e.g., in order to divide the rendering workload between different devices. For example, the rendering may be split between a server and a client device, which may be referred to as “split rendering.” In some instances, split rendering may be a method for bringing content to client devices, where a portion of the graphics processing may be performed outside of the client device, e.g., at a server. In some aspects, the server may be at least one of: a phone, a smart phone, a computer, or a cloud server. Further, the client device may be at least one of: a headset, a head mounted display (HMD), display glasses, or smart glasses.

Split rendering may be performed for a number of different types of applications (e.g., virtual reality (VR) applications, augmented reality (AR) applications, mixed reality (MR) applications, and/or extended reality (XR) applications). In VR applications, the content displayed at the client device may correspond to man-made or animated content. In XR, AR, or MR content, a portion of the content displayed at the client device may correspond to real-world content (e.g., objects in the real world), and a portion of the content may be man-made or animated content. Also, the man-made or animated content and real-world content may be displayed in an optical see-through or a video see-through device, such that the user may view real-world objects and man-made or animated content simultaneously. In some aspects, man-made or animated content may be referred to as augmented content, or vice versa. Split XR, AR, or MR systems may also introduce latency when delivering the rendered content to the client display. In some aspects, this latency may be even higher when rendering occurs on a server than compared to client rendering, but it can also enable more complex XR, AR, or MR applications. In addition, there may be non-negligible latency between the time a camera pose is computed and the time the content appears on the client display. For instance, a certain amount of latency may be present in split XR, AR, or MR systems.

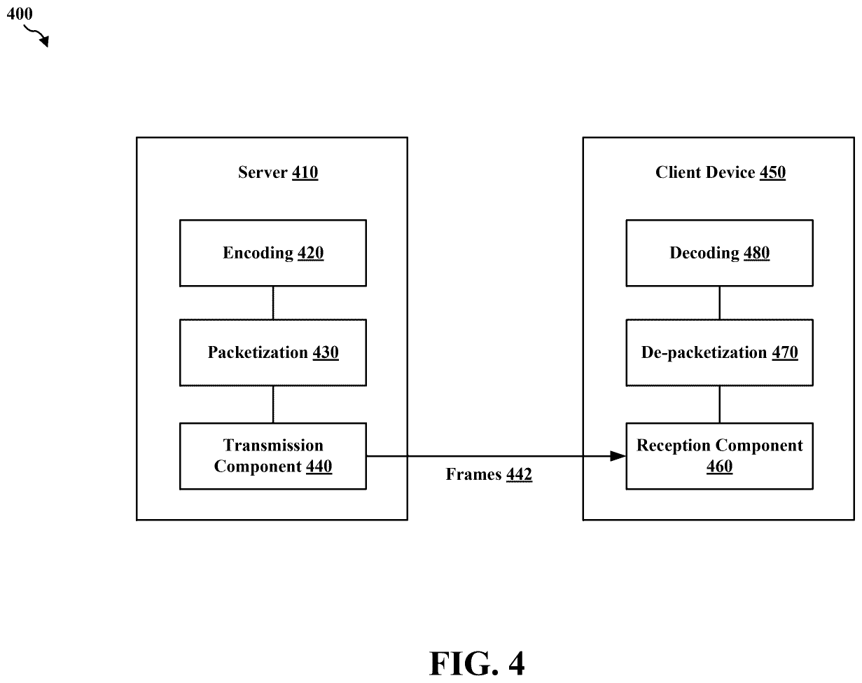

FIG. 4 illustrates diagram 400 including communication of content/data in accordance with a split rendering process. As shown in FIG. 4, diagram 400 includes server 410 and client device 450 associated with the split rendering process. FIG. 4 shows a number of processes that are performed at the server 410 and the client device 450 including an encoding process 420, a packetization process 430, a de-packetization process 470, and a decoding process 480. Server 410 and client device 450 also include a transmission component 440 and a reception component 460, respectively.

As shown in FIG. 4, on the server 410, data/content associated with images/frames may be encoded during encoding process 420. After encoding process 420, the data/content may then undergo a packetization process 430, e.g., a real-time transport protocol (RTP) packetization process. During the packetization process, the data/content may be converted to one or more frames 442. The frames 442 may then be transmitted from the transmission component 440 of server 410 to the reception component 460 of client device 450. In some instances, the frames may be transmitted via a user datagram protocol (UDP) internet protocol (IP) (UDP/IP) network protocol, a transmission control protocol (TCP) IP (TCP/IP) network protocol, or any other network protocol. On the client device 450, the frames 442 may be received via the reception component 460 (e.g., received via a UDP/IP network protocol, a TCP/IP network protocol, or any other network protocol). The frames 442 may also undergo a de-packetization process 470 (e.g., a real-time transport protocol (RTP) de-packetization process or any other protocol de-packetization process), which may convert the data packets into data/content. After de-packetization, the data/content may be decoded during decoding process 480. Finally, the decoded data/content may be sent to a display or HMD of client device 450 for display of the data/content.

As indicated above, aspects of graphics processing may deal with rendering or displaying different types of content (e.g., virtual reality (VR) applications, augmented reality (AR) applications, mixed reality (MR) applications, and/or extended reality (XR) applications). The content may be rendered or created on a server, e.g., a computer or phone. To display this content, users may utilize different types of headsets or display glasses, which may be referred to as a client device. In some instances, when a user wants to use XR glasses for a long duration in the absence of a charging facility, it is desirable to save power at the server or client device. Also, when the battery of either the client device or the server is getting low (i.e., beyond a threshold percentage decided by the user) it is desirable to save power at the server or client device. Moreover, if a user wants to extent battery life voluntarily, then it is desirable to save power at the server or client device and provide a long battery life to either device.

In split rendering applications, content may be rendered on servers and encoded/streamed to XR-based HMDs over Wi-Fi. As indicated above, split rendering means the XR workload may be split between two devices, i.e., the host/server and the client/HMD. For example, one use case may be a smartphone connected to HMD/AR glasses. AR glasses may not have high processing capabilities, and heat dissipation may be an issue if all the processing is performed on the client/glasses. Accordingly, it is beneficial to split the rendering between the server and the client device.

In one aspect, a pose (e.g., a six degree of freedom (6DOF) pose) may be generated on the client device. The client/HMD may send the 6DOF pose data to the server via an uplink connection. An application or game may then render the content using the transmitted 6DOF pose on the server/phone. Also, the encoding of rendered content may occur on the server/phone. The encoded and compressed bit stream may then be transmitted from the server/phone to the HMD/client via a downlink connection. After this, video decoding and time warp processing may be performed on the HMD/client using the latest 6DOF pose. Finally, the HMD/client may display the re-projected content.

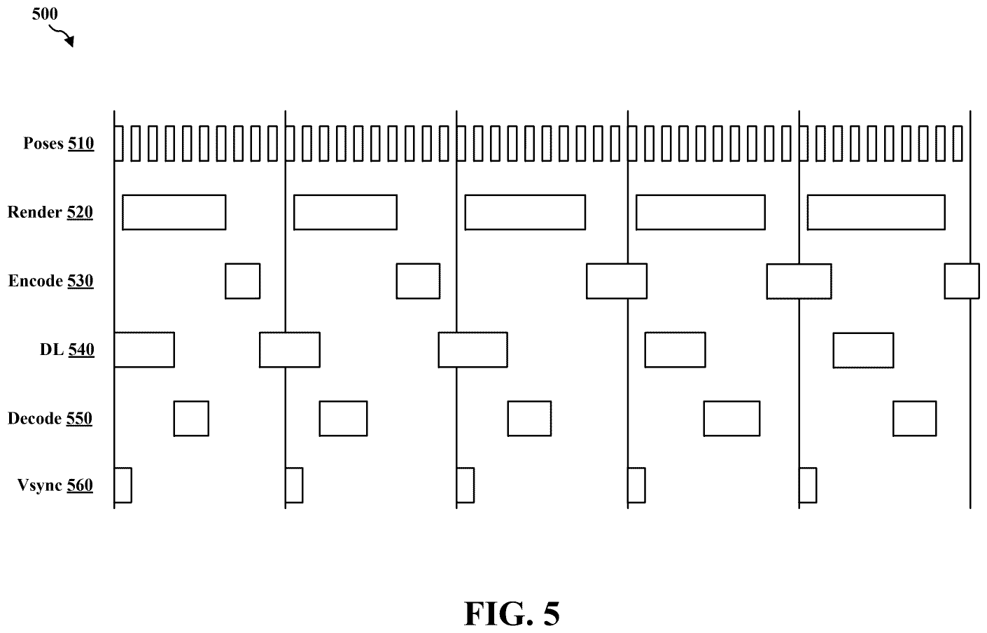

FIG. 5 illustrates a diagram 500 of an example timeline of a split rendering process. More specifically, FIG. 5 shows a diagram 500 of a timeline of different processing steps at a server (e.g., phone, smart phone, or computer) and a client device (e.g., headset, HMD, or smart glasses). For instance, a client device may transmit a number of poses 510 (e.g., head poses) to the server. The server may then render content for a frame at render process 520, as well as encode the frame at encode process 530. Also, the server may transmit the frame to the client device via downlink (DL) 540. After receiving the frame, the client device may decode the frame at decode process 550. FIG. 5 also shows a vertical synchronization (VSync) 560 that is associated with each of the transmissions.

As shown in FIG. 5, head pose data may be transmitted from the client device to the server (via uplink (UL)) at a high rate (e.g., 500 Hz) and/or a low latency. The client device (e.g., HMD/glasses) may be unaware of the rendering start time on the server (e.g., phone). The rendering of the first frame on the server may start at an arbitrary time using the latest pose followed by the rendering of future frames at a preconfigured frames-per-second (fps or FPS) rate. A rendering thread may render frames as fast as a GPU allows without any wait time, and in order to limit the fps, the wait time may be added at the end of each rendering. Also, the rendering thread may sleep until the wait time before starting the rendering for the next frame. Further, upon rendering, each rendered frame may be immediately queued for encoding. Once the encoding is completed, encoded frames may be packetized and transmitted (via downlink (DL)) at an arbitrary time (e.g., the post-rendering time plus the encode time). In some examples, a Wi-Fi modem may be always “on” so that the pose and frames may be transmitted with a minimum latency. Also, in some examples, on the UL side, a number of different types of information or data may also be transmitted (e.g., camera streaming data, color data or red (R) green (G) blue (B) (RGB) data, hand tracking data, and/or three-dimensional (3D) rendering (3DR) data).

Some aspects of split rendering may utilize a number of different features, such as a target wake time (TWT) and a timing synchronization function (TSF). The TWT feature may allow a modem/radio frequency (RF) to be to switched on at a fixed cadence and for a known service period. This TWT feature may be utilized to save power on the server and the client device. While TWT may ensure a power reduction on the modem side, the selection of TWT parameters may influence XR performance, such as the latency and frame reuse (i.e., judder). In some instances, the TWT feature may allow UL (pose) data and DL (rendered+encoded) frame data to be aligned with a TWT service period (on period), i.e., the transmission (Tx) and reception (Rx) on the client device and the server may happen simultaneously. When data is transmitted simultaneously within the same service period, it may provide the modem a chance to sleep for a certain time, which may reduce power and thermal issues. In some split XR scenarios, each client may have a timer synchronized with a timing synchronized function (TSF), e.g., associated with a server. Additionally, early termination may allow a service period to be terminated early on detection of inactivity of DL/UL data. Early termination processes may include an end of service period (EOSP). For example, the ESOP may terminate a service interval (i.e., transition the service interval from an “on” period to an “off” period). TWT may allow a modem to turn on and off at a defined cadence. TWT may also support early termination, such as if data is not present for transmission for a defined time period, the modem may turn off

As indicated herein, there may be multiple subsystems that are involved in an XR pipeline from end to end. For example, a CPU, a GPU, an encoder, a decoder, a network, a server (e.g., a smartphone), and/or a client device (e.g., a headset, HMD, or AR glasses) may be involved in an end-to-end XR pipeline. Some types of client devices (e.g., wireless AR glasses) may need to have a sleek and lightweight design/form factor, which may pose a number of different issues, such as battery consumption (e.g., around 800 mW for system-on-chip (SOC) and double data rate (DDR) memory for some devices) and/or thermal dissipation. Additionally, in order to achieve a high quality user experience, certain display characteristics or conditions may be desired by the server and/or client device. For example, for a high quality user experience, a minimal amount of motion-to-render-to-photon (M2R2P) latency may be desired. Further, a minimal amount of frame loss or repeat may be desired by the server and/or client device.

Extended reality (XR), augmented reality (AR), and mixed reality (MR) applications typically use a viewing device for a user, such as a headset, a head-mounted device (HMD), and/or a glass). However, the use of headsets, head-mounted devices (HMDs), and/or glasses within extended reality (XR) has created a number of issues. For instance, headsets, HMDs and XR glasses may be expensive because they have extreme cutting escape abilities. These devices may also be power hungry, as they may include an external battery pack with a tether. Indeed, there are a lot of challenges for the use of XR, AR, and MR digital glasses, due to its smaller factor than UE and tougher power limit (e.g., chipset power is less than 500 mW). In a typical split XR architecture, the distributed processor may be divided between the XR glass and server (e.g., UE or cloud edge server). Also, the power consumption may be too high for demanding XR/AR/MR applications, due to involvement of local processing and long-range communication. Another approach is aggressively offloading from XR/AR/MR applications to a nearby server (e.g., UE or cloud edge server). This may convert an XR/AR/MR device to share all the local sensor with the server (e.g., UE or cloud edge server) without pro-processing. Additionally, this may obtain from the server or UE rendered videos without post-processing, such as over an ultra-wide band (UWB) connection. By doing so, there may be significant power reduction, but this still may not draw down the power consumption to an acceptable range (e.g., less than 1 to 3 W).

There are also other types of XR/AR/MR glasses, such as a digital glass (DG), that is different from typical mixed reality (MR), augmented reality (AR), or virtual reality (VR) headsets. A digital glass may refer to low power glass, headset or head-mounted display (HMD) for use in XR/AR/MR applications. For example, a digital glass may refer to a simple heads-up device that allows a user to see key notifications that today you might consume on the screen of the phone or on a digital watch. In both of these cases, a user may have to look down at the digital glass. For instance, a digital glass (e.g., an AR/VR/MR digital glass) may be a power efficient lightweight, simple device that allows a notification (e.g., a heads-up notification) and has a number of key sensors. A digital glass may also include other features, such as cameras and microphones, as well as earbuds to listen to music. Also, a digital glass may be a low power device, as well as include other types of qualities, such as being lightweight and inconspicuous. These types of devices may be utilized for a long amount of time, so they may need a long life from a small battery. Based on the above, it may be beneficial to reduce the amount of power consumption at these types of devices. Also, it may be beneficial to reduce the amount of processing functions at these types of devices. Further, it may be beneficial to increase the amount of battery life that is available at low power devices (e.g., digital glasses).

Aspects of the present disclosure may reduce the amount of power consumption at low power devices or ultra-low power devices (e.g., a digital glass). For instance, aspects presented herein may increase the amount of battery life at low power devices or ultra-low power devices (e.g., a digital glass). Also, aspects presented herein may reduce the amount of processing functions at low power devices or ultra-low power devices (e.g., a digital glass). In order to do so, aspects of the present disclosure may adjust processing functions that, in turn, may reduce the power consumption for a low power devices or ultra-low power devices (e.g., a digital glass). For example, aspects presented herein may reduce the amount of key processing functions that are utilized at low power devices or ultra-low power devices (e.g., a digital glass). That is, aspects presented herein may offload certain processing functions to another device (e.g., a server or UE). By doing so, aspects presented herein may reduce the amount of processing functions, which in turn may reduce the amount of power consumption at low power devices (e.g., digital glass). For example, aspects presented herein may transfer processing functions to a server (e.g., a cloud server, an edge server, or a UE. Indeed, aspects presented herein may offload processing functions via a wireless personal network (WPN) to a companion device (e.g., a server or UE).

Aspects presented herein may alleviate issues of XR/MR/AR digital glasses, which may be smaller than servers (e.g., UEs) and also include more challenging power limits (e.g., chipset power is less than 500 mW). In a split XR architecture, the processing may be distributed across an XR glass and a server (e.g., a UE, cloud server, or edge server). In these types of architectures, the power consumption may be too high for demanding AR applications, which may be due to the involvement of local processing and long-range communication. Aspects presented herein propose to offload most of the processing functions via a wireless personal network (WPN) to a companion server (e.g., a UE, cloud server, or edge server). Aspects presented herein may also utilize a synchronized upload and download capability with a server (e.g., a UE, cloud server, or edge server). Aspects presented herein may also allow for processing with on-chip static random access memory (SRAM) on the device, as well as removing dynamic random access memory (DRAM) on the device, as DRAM may add cost, power, and space on the device. Further, aspects presented herein may utilize a small non-volatile (NV) memory and a companion UE to boot and operate the devices. Aspects presented herein may also put most of an AR chip to sleep after each transfer, except a sensor hub. Aspects presented herein may also utilize retention flops to keep the necessary context states. Moreover, aspects presented herein may switch to a low power oscillator to clock a sensor hub and timer.

In some instances, aspects presented herein may power down when not in use to initiate a boot from non-volatile RAM, establish a wireless personal network (WPN), and then request the rest of the boot image via the WPN. Aspects presented herein may also utilize an aggregation of wakeup/power down decisions at the end of a synchronization time window (STW). Further, aspects presented herein may also utilize certain wake-up conditions and/or commands from a server (e.g., a UE, cloud server, or edge server) or digital glass (DG). Aspects presented herein may also utilize a partial power down with partial state retention conditions, such as by utilizing an event hysteresis in order to indicate activities that are likely to occur within a certain time period (e.g., 1-10 seconds). Aspects presented herein may also utilize preset head motions detected by a sensor hub (i.e., for hands-off control). Aspects presented herein may also utilize a balloon style retention register in order to hold key states. Aspects presented herein may also utilize a full power down condition, such as an event hysteresis that indicates activities that are not likely to occur within a certain time period (e.g., 1-10 seconds). In a full power down, there may be a need to push the power up button to restart.

In some aspects, in order to show video on a screen, low power devices or ultra-low power devices (e.g., a digital glass) may need to decode the video that comes in from the network stream, and then render it on screen. So there may be a video processing decoding portion for the device, as well as a video encoding portion, as the glasses are likely to have cameras, and there may be a need to capture what is happening around the device. So these devices may utilize video encoding, as well as audio or microphones, in order to capture what is around the device. These devices may also utilize post sensors in order to determine the orientation of the device or the head orientation. Accordingly, these devices may couple that information together with whatever information is rendered on the screen. Aspects presented herein propose to utilize a specific processor at the device, instead of using general purpose processors to do all of these general functions, which may consume more power. For instance, if instructions are performed on a platform that can do a variety of things, but not necessarily anything specifically efficiently, then this may utilize more power. In contrast, aspects presented herein may replace general purpose processors with a simple asynchronous operation for those key functions, such as by utilizing a small processor to manage the device. This may include functions for the speakers, the cameras, the microphones, and the sensor hub that detects activity in the sensor hub. Aspects presented herein may utilize decoders and encoders and include the pose information and then send it out of the modem. Aspects presented herein may perform these operations in hardware at the device (e.g., application-specific integrated circuit (ASIC) hardware), so they can be executed in the most power efficient way, and then sent to another device (e.g., a server or UE) that may include a general purpose processor. This other device that may include a general purpose processor (e.g., a server or UE) may include the bulk of the memory (e.g., the DRAM) and have the ability to run different applications. Whereas the key capabilities at the device (e.g., digital glass) may be performed at the hardware (e.g., ASIC hardware) to deliver those capabilities in the most efficient way for the longest battery life at the device (e.g., digital glass). Indeed, the bulk of the processing may occur at the companion device (e.g., a server or UE).

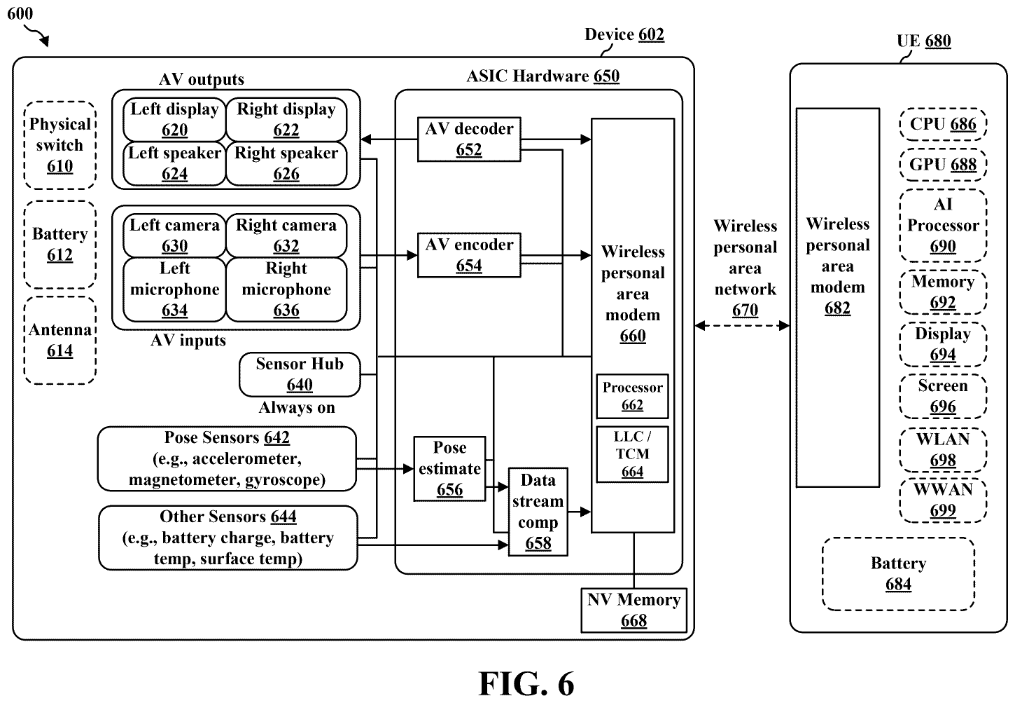

FIG. 6 is a diagram 600 illustrating an example diagram of a split rendering process. More specifically, diagram 600 depicts a low-power device or digital glass (e.g., device 602) and a companion UE (e.g., UE 680). As shown in FIG. 6, diagram 600 includes device 602 including physical switch 610, battery 612, antenna 614, audio-video (AV) outputs (left display 620, right display 622, left speaker 624, right speaker 626), AV inputs (left camera 630, right camera 632, left microphone 634, right microphone 636), sensor hub 640 (i.e., always on), pose sensors 642 (e.g., accelerometer, magnetometer, gyroscope), and other sensors 644 (e.g., battery charge, battery temperature, surface temperature). Device 602 (e.g., low-power device or digital glass) also includes ASIC hardware 650 including AV decoder 652, AV encoder 654, pose estimate 656, data stream compressor 658, wireless personal area modem 660 (including processor 662 and last level cache (LLC)/tightly-coupled memory (TCM) (LLC/TCM) 664), as well as non-volatile (NV) memory 668. The LLC/TCM 664 may include certain types of memory, such as level 3 cache/memory or scratchpad memory. As depicted in FIG. 6, there may be a certain process flow between the aforementioned components (as depicted with arrows in FIG. 6 between the components in device 602). For instance, there may be a process flow from AV decoder 652 to AV outputs, as well as to wireless personal area modem 660. There may also be a process flow from AV inputs to AV encoder 654 and to wireless personal area modem 660. Further, there may be a process flow from pose sensors 642 to pose estimate 656 to data stream compressor 658, and to wireless personal area modem 660. There may also be a process flow from other sensors 644 to data stream compressor 658, and to wireless personal area modem 660. UE 680 includes wireless personal area modem 682, battery 684, CPU 686, GPU 688, artificial intelligence (AI) processor 690, memory 692, display 694, screen 696, wireless local area network (WLAN) 698, and wireless wide area network (WWAN) 699. As shown in FIG. 6, device 602 and UE 680 include a wireless personal area network 670 between the devices. This wireless personal area network 670 may be utilized to offload certain functions from the device 602 to the UE 680.

As shown in FIG. 6, device 602 (e.g., low-power device or digital glass) includes ASIC hardware 650 (e.g., a drill bit optimized hardened ASIC), as well as a lack of double data rate (DDR) memory. By utilizing the ASIC hardware 650 and lack of DDR memory, device 602 may be able to achieve a power reduction compared to similar devices. Device 602 also utilizes a NV memory 668, which may be similar to a flash memory that holds the code programs that can loaded up by the processor 662. The processor 662 may include a basic configuration, and it may not include a complex program that that relies on a power hungry memory (e.g., DDR memory) in order to hold the program. That is, the NV memory may allow the device 602 to boot up and start, and then device 602 may obtain the remaining content from the companion UE (e.g., UE 680) for processing (i.e., due to the lack of DDR memory at device 602). Indeed, the use of ASIC hardware 650, as well as the lack of DDR memory, allows the device 602 to offload complex calculations to UE 680, which in turn allows device 602 to function at a low power level. So there is no high level operating system running on device 602 for application management. And from an end user perspective, there is no high power operating system to run a diversity of applications (e.g., user selectable applications). As such, the device 602 (e.g., digital glass) may function as a sort of companion device the UE 680 (e.g., smartphone), where the UE 680 may include all the flexibilities and processing capabilities that the glass is offloading.

In some instances, the device 602 (e.g., digital glass) may offload processing capabilities the UE 680 (e.g., smartphone), which may have a larger battery and it be easier to recharge than the device. Also, users may be able to run multiple apps and switch between them with a convenient interface. That is, aspects presented herein may allow the device 602 (e.g., digital glass) to offload a variety of capabilities to the UE 680 (e.g., smartphone), which allows the glass to be designed to run for a long period of time and be lightweight. Also, the device 602 (e.g., digital glass) may be convenient to wear for those long periods of time, while offloading the complex operations to the UE 680 (e.g., smartphone).

As shown in FIG. 6, aspects presented herein may offload processing capabilities at a digital glass (e.g., device 602) to a companion UE (e.g., UE 680) via a wireless personal network (WPN) (e.g., wireless personal area network 670). Aspects presented herein may also allow for a synchronized upload and download capabilities between a digital glass (e.g., device 602) and a companion UE (e.g., UE 680). Aspects presented herein may also allow for a digital glass (e.g., device 602) to process with solely an on-chip SRAM. Indeed, aspects presented herein may allow digital glass (e.g., device 602) to not include any DRAM on the device. As DRAM adds cost, power, and space to the device, this may allow a digital glass (e.g., device 602) to save on cost, power, and/or space at the device. Further, aspects presented herein may utilize a small memory (e.g., NV memory 668) and allow the companion UE (e.g., UE 680) to boot and operate the digital glass (e.g., device 602). Aspects presented herein may also allow for a digital glass (e.g., device 602) to put most of the AR chips to sleep after each transfer (except a sensor hub). Aspects presented herein may also allow for a digital glass (e.g., device 602) to use retention flops in order to keep necessary context states. Moreover, aspects presented herein may allow for a digital glass (e.g., device 602) to switch to a low power oscillator in order to clock a sensor hub and timer. Aspects presented herein may also allow for a digital glass (e.g., device 602) to power down when not in use. Aspects presented herein may also allow for a digital glass (e.g., device 602) to initiate a boot from a non-volatile RAM (e.g., NV memory 668) in order to establish a WPN (e.g., wireless personal area network 670). Additionally, aspects presented herein may allow for a digital glass (e.g., device 602) to request the rest of a boot image via a WPN (e.g., wireless personal area network 670).

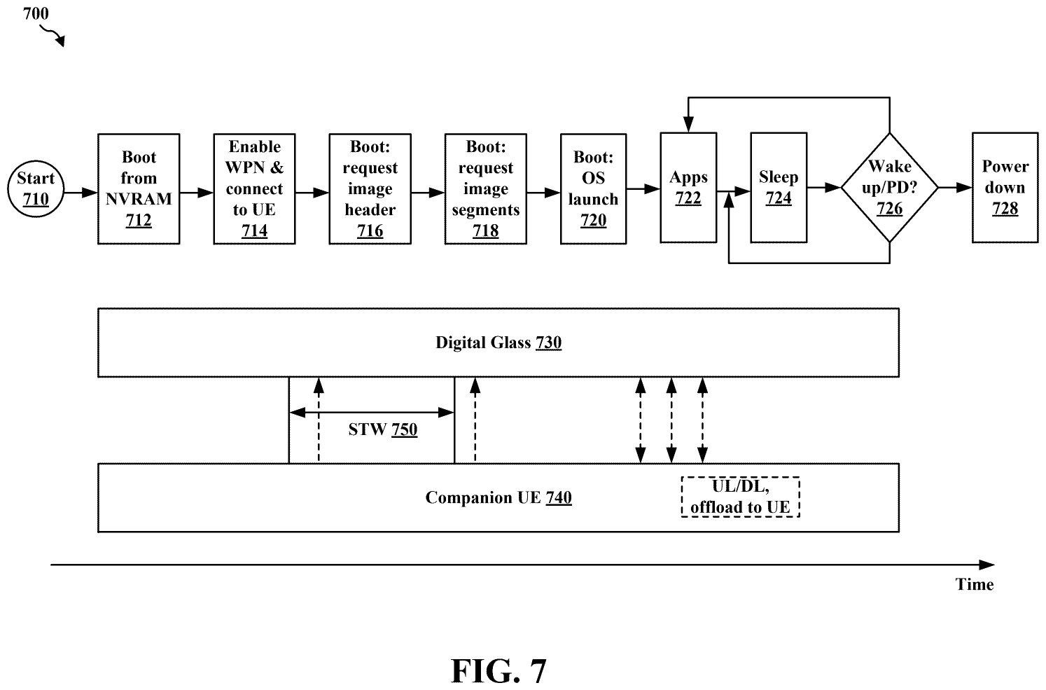

FIG. 7 is a diagram 700 illustrating an example flow diagram for a split rendering process. More specifically, diagram 700 depicts a flow diagram with a pre-determined synchronization time window (STW). As shown in FIG. 7, diagram 700 includes a number of steps that are performed at the digital glass 730 that includes a synchronization time window (STW) (e.g., STW 750) with a companion UE 740. The companion UE 740 may allow the digital glass 730 a simultaneous upload/download capability, as well as the ability for digital glass 730 to offload certain calculations to the companion UE 740. At 710, digital glass 730 may start the process with the companion UE 740. At 712, digital glass 730 may boot from the non-volatile memory (e.g., NV RAM). For example, at 712, digital glass 730 may initialize a setup of a modem of the wireless device for a wireless connection with UE 740. At 714, digital glass 730 may enable a wireless personal network (e.g., wireless personal area network 670) and connect to UE 740. For example, at 714, digital glass 730 may establish the wireless connection with the UE 740 and connect to UE 740. At 716, digital glass 730 may boot a request for an image header. For example, at 716, digital glass 730 may transmit, to the UE 740, a request for a header of at least one image. At 718, digital glass 730 may boot a request for image segments. For example, at 718, digital glass 730 may transmit, to the UE 740, a request for a set of image segments for the at least one image. The header of the at least one image may comprise at least one of: an amount of the set of image segments, a size of each of the set of image segments, an offset for each of the set of image segments, or a starting address for each of the set of image segments. Also, each of the set of image segments may comprise at least one of: data for the at least one image or a set of instructions for the at least one image.

As further shown in FIG. 7, at 720, digital glass 730 may boot an operating system (OS) launch. For example, at 720, digital glass 730 may configure a set of components of the digital glass 730 based on one or more of the header of the at least one image or the set of image segments for the at least one image. At 722, digital glass 730 may start one or more applications at the device. For example, at 722, digital glass 730 may initiate, based on the configuration of the set of components, a set of applications of the device. At 724, digital glass 730 may initiate a sleep mode. For example, at 724, digital glass 730 may initiate, based on a determination to sleep, a sleep mode at the device including a partial power down mode of the device based on a set of partial state retention conditions. The set of partial state retention conditions may comprise at least one of: an event hysteresis, a user input motion, or a preset head motion. Also, initiating the partial power down mode at the wireless device may comprise: initiating a power down of a static random access memory (SRAM) at the device. At 726, digital glass 730 may determine whether to wake up or power down. For example, at 726, digital glass 730 may determine, based on an initiation of the set of applications, whether to wake-up, sleep, or power down the wireless device. At 728, digital glass 730 may power down the device. For example, at 728, digital glass 730 may initiate, based on a determination to power down, a full power down at the device based on at least one of: an event hysteresis, a user input motion, or a preset head motion.

Additionally, as depicted in FIG. 7, aspects presented herein may include an aggregation of wakeup/power down decisions. For instance, aspects presented herein may utilize an aggregation of wakeup/power down decisions at the end of a synchronization time window (STW) (e.g., STW 750). Aspects presented herein may also utilize a number of wake up conditions (e.g., at 726, digital glass 730 may determine whether to wake up or power down). For example, aspects presented herein may utilize a command from companion UE 740 or digital glass 730. Aspects presented herein may also utilize a partial power down with partial state retention conditions (e.g., at 724, digital glass 730 may sleep). For example, aspects presented herein may utilize an event hysteresis that indicates activities that are likely within a certain time period (e.g., 1-10 seconds). Also, aspects presented herein may utilize a preset head motion detected by a sensor hub (for hands-off control). Aspects presented herein may also utilize balloon style retention registers in order to hold key states. Aspects presented herein may also utilize full power down conditions at a digital glass (e.g., at 728, digital glass 730 may power down the device). For example, aspects presented herein may utilize event hysteresis that indicates activities that are not likely within a certain time period (e.g., 1-10 seconds). As shown in FIG. 7, aspects presented herein may perform a full power down at a digital glass (e.g., at 728, digital glass 730 may power down the device). Moreover, aspects presented herein may need to push a power up button in order to restart the device (e.g., digital glass 730).

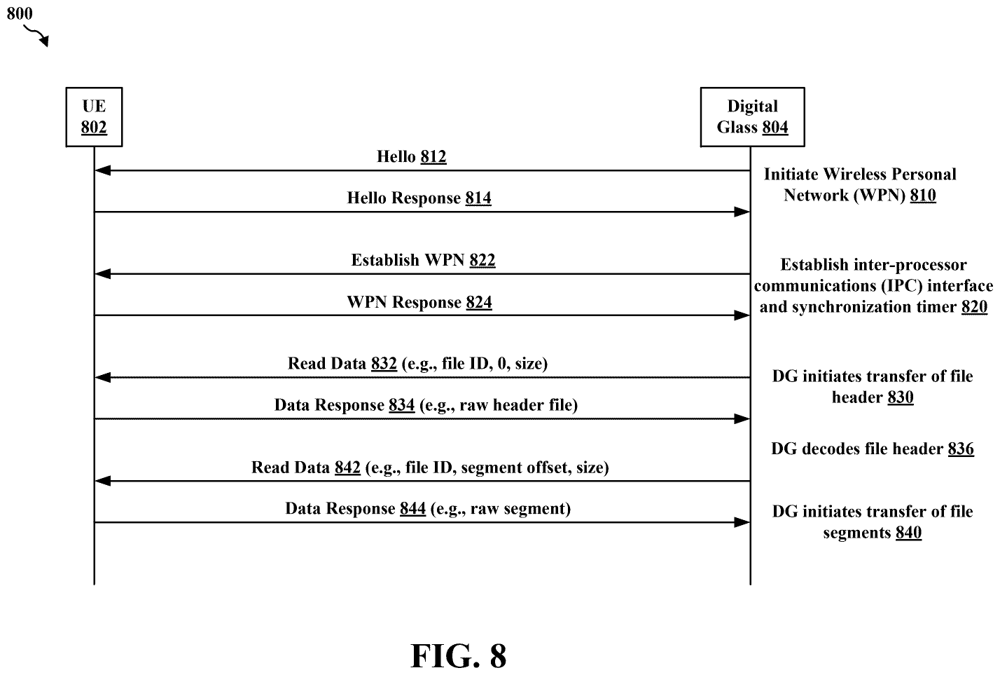

FIG. 8 is a diagram 800 illustrating an example flow diagram for a split rendering process. More specifically, diagram 800 depicts a flow diagram for offloading an uplink/downlink operation including a boot and other operations. As shown in FIG. 8, diagram 800 includes a number of steps that are performed at the digital glass 804 with a companion UE (e.g., UE 802). The UE 802 may allow the digital glass 804 a simultaneous upload/download and/or uplink/downlink capability, as well as the ability for digital glass 804 to offload certain calculations to the UE 802. At 810, digital glass 804 may initiate a wireless personal network (WPN). For example, at 810, digital glass 804 may transmit an initial communication request and receive an initial communication response from the UE 802. That is, at 812, digital glass 804 may transmit a hello request to UE 802. At 814, digital glass 804 may receive a hello response from UE 802. At 820, digital glass 804 may establish an inter-processor communications (IPC) interface and synchronization timer. For example, at 822, digital glass 804 may establish WPN with UE 802. At 824, digital glass 804 may receive a WPN response from UE 802. Indeed, digital glass 804 may transmit, to the UE 802, a request to establish the wireless connection with the UE; and receive, from the UE 802, a confirmation to establish the wireless connection with the UE, where the confirmation is at least one of: an acknowledgement (ACK), a heartbeat, a beacon, a response, or an indication of a synchronization timer.

As further shown in FIG. 8, at 830, digital glass 804 may initiate a transfer of a file header. For example, at 832, digital glass 804 may read data (e.g., a file identifier (ID), 0, size) or transmit data to UE 802. At 834, digital glass 804 may receive a data response (e.g., a raw header file) from UE 802. That is, digital glass 804 may receive, from the UE 802, one or more of the header of the at least one image or the set of image segments for the at least one image. At 836, digital glass 804 may decode a file header. Indeed, digital glass 804 may store, in memory, one or more of the header of the at least one image or the set of image segments for the at least one image, where the memory of the wireless device is on-chip memory of the wireless device or static random access memory (SRAM) of the device. At 840, digital glass 804 may initiate a transfer of file segments. For example, at 842, digital glass 804 may read data (e.g., a file identifier (ID), segment offset, size) or transmit data to UE 802. At 844, digital glass 804 may receive a data response (e.g., a raw segment) from UE 802. In some aspects, the set of components of the device may comprise: a set of hardware components of the wireless device or a set of application-specific integrated circuit (ASIC) hardware components of the wireless device. Also, the set of hardware components of the device may comprise at least one of: an audio-visual (AV) decoder, an AV encoder, a pose estimate component, a data stream compressor component, a set of AV output components, a set of AV input components, a sensor hub, an accelerometer sensor, a gyroscope sensor, a temperature sensor, or a health sensor.

In some instances, aspects presented herein may utilize a boot operation at a device (e.g., a digital glass), as well as operation of a processor without DDR memory at the device (e.g., a digital glass). In order to do so, aspects presented herein may leverage a companion device (e.g., a UE or a server). Aspects presented herein may utilize certain device functions (e.g., digital glass functions) as a thin-client display glass, such as for UE content. By doing so, aspects presented herein may allow for intelligent sleep at the device (e.g., a digital glass), as well as partial and full power down decisions at the device (e.g., a digital glass). In turn, this may allow for aggressive power savings at the device (e.g., a digital glass). Additionally, this aforementioned steps may allow aspects presented herein to utilize an ultra-low power consumer or enterprise smart glasses for a digital glass. Indeed, this may allow for the use of a low-powered device (e.g., glass or headset) within XR/AR/MR split rendering. By utilizing a low-powered glass or headset, this may reduce the cost of the device for XR/AR/MR split rendering, as well as extend the lifetime of the device for XR/AR/MR split rendering.

Aspects of the present disclosure may include a number of benefits or advantages. For instance, aspects presented herein may reduce the amount of power consumption at low power devices or ultra-low power devices (e.g., a digital glass). For instance, aspects presented herein may increase the amount of battery life at low power devices or ultra-low power devices (e.g., a digital glass). Also, aspects presented herein may reduce the amount of processing functions at low power devices or ultra-low power devices (e.g., a digital glass). In order to do so, aspects of the present disclosure adjust processing functions that, in turn, may reduce the power consumption for a low power devices or ultra-low power devices (e.g., a digital glass). For example, aspects presented herein may reduce the amount of key processing functions that are utilized at low power devices or ultra-low power devices (e.g., a digital glass). That is, aspects presented herein may offload certain processing functions to another device (e.g., a server or UE). By doing so, aspects presented herein may reduce the amount of processing functions, which in turn may reduce the amount of power consumption at low power devices (e.g., digital glass). For example, aspects presented herein may transfer processing functions to a server (e.g., a cloud server, an edge server, or a UE. Indeed, aspects presented herein may offload processing functions via a wireless personal network (WPN) to a companion device (e.g., a server or UE).

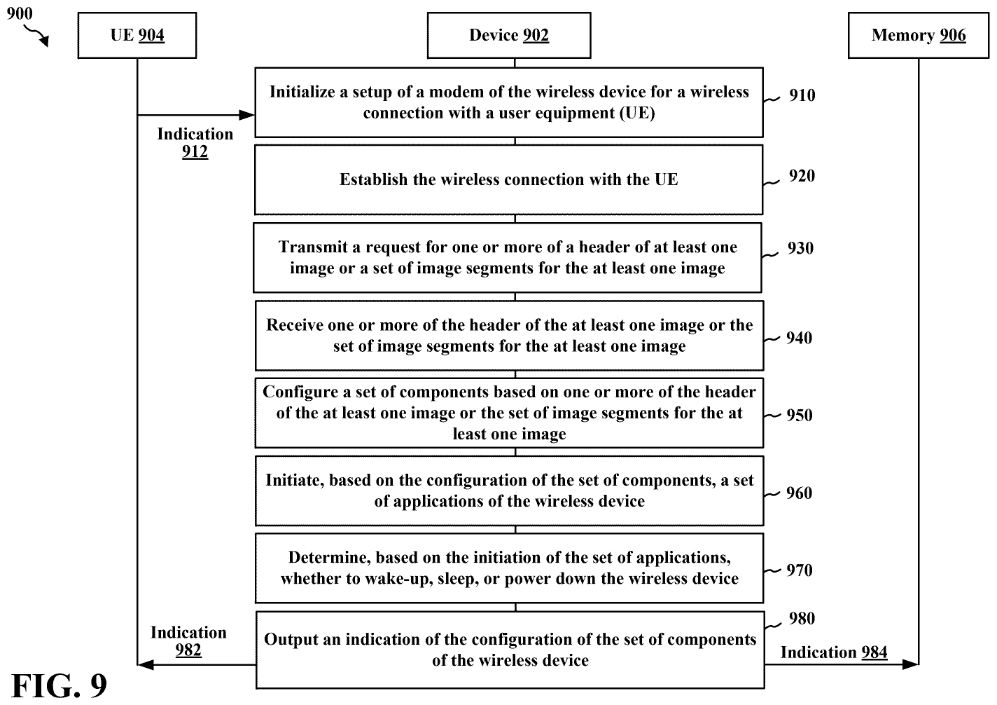

FIG. 9 is a communication flow diagram 900 of frame processing in accordance with one or more techniques of this disclosure. As shown in FIG. 9, diagram 900 includes example communications between device 902 (e.g., a client device, a headset, HMD, AR glasses, a server, phone, or smartphone), UE 904 (e.g., a server, a phone, a smartphone, a client, a headset, HMD, or AR glasses), and memory 906 (e.g., a memory or a cache), in accordance with one or more techniques of this disclosure.

At 910, device 902 (e.g., a wireless device) may initialize a setup of a modem of the device for a wireless connection with a user equipment (UE) (e.g., device 902 may receive an indication 912 from UE 904 to initialize the setup). In some aspects, initializing the setup of the modem of the wireless device may comprise: booting the setup of the modem from a non-volatile (NV) memory. The wireless connection may be at least one of: a wireless personal network (WPN) connection, an ultra-wide band (UWB) connection, a Bluetooth connection, a Bluetooth low energy (BLE) connection, or a Wi-Fi connection. Also, the wireless device may be at least one of a headset, a head mounted device (HMD), a glass, a digital glass, or a wearable device.

At 920, device 902 may establish the wireless connection with the UE. In some aspects, establishing the wireless connection with the UE may comprise transmitting, to the UE, a request to establish the wireless connection with the UE; and receiving, from the UE, a confirmation to establish the wireless connection with the UE, where the confirmation is at least one of: an acknowledgement (ACK), a heartbeat, a beacon, a response, or an indication of a synchronization timer.

At 930, device 902 may transmit, to the UE, a request for one or more of a header of at least one image or a set of image segments for the at least one image. In some aspects, the header of the at least one image may comprise at least one of: an amount of the set of image segments, a size of each of the set of image segments, an offset for each of the set of image segments, or a starting address for each of the set of image segments. Also, each of the set of image segments may comprise at least one of: data for the at least one image or a set of instructions for the at least one image.

At 940, device 902 may receive, from the UE, one or more of the header of the at least one image or the set of image segments for the at least one image. Also, at 940, device 902 may store, in memory of the wireless device, one or more of the header of the at least one image or the set of image segments for the at least one image, where the memory of the wireless device is on-chip memory of the wireless device or static random access memory (SRAM) of the wireless device.

At 950, device 902 may configure a set of components of the wireless device based on one or more of the header of the at least one image or the set of image segments for the at least one image. In some aspects, the set of components of the wireless device may comprise: a set of hardware components of the wireless device or a set of application-specific integrated circuit (ASIC) hardware components of the wireless device. Also, the set of hardware components of the wireless device may comprise at least one of: an audio-visual (AV) decoder, an AV encoder, a pose estimate component, a data stream compressor component, a set of AV output components, a set of AV input components, a sensor hub, an accelerometer sensor, a gyroscope sensor, a temperature sensor, or a health sensor.

At 960, device 902 may initiate, based on the configuration of the set of components, a set of applications of the wireless device. In some aspects, initiating the set of applications of the wireless device may comprise transmitting, to the UE, a request for audio-visual (AV) content; receiving the AV content from the UE; and outputting the AV content for the set of applications. Also, receiving the AV content from the UE may comprise receiving the AV content from the UE; and storing, in on-chip memory of the wireless device, the AV content from the UE. Further, outputting the AV content for the set of applications may comprise displaying the AV content for the set of applications; or activating the AV content for the set of applications.

At 970, device 902 may determine, based on the initiation of the set of applications, whether to wake-up, sleep, or power down the wireless device. Also, at 970, device 902 may initiate, based on the determination, a sleep mode at the wireless device including a partial power down mode of the wireless device based on a set of partial state retention conditions. In some aspects, the set of partial state retention conditions may comprise at least one of: an event hysteresis, a user input motion, or a preset head motion. Further, initiating the partial power down mode at the wireless device may comprise: initiating a power down of a static random access memory (SRAM) at the wireless device. Also, at 970, device 902 may initiate, based on the determination, a full power down at the wireless device based on at least one of: an event hysteresis, a user input motion, or a preset head motion.

At 980, device 902 may output an indication of the configuration of the set of components of the wireless device. In some aspects, outputting the indication of the configuration of the set of components of the wireless device may comprise transmitting the indication of the configuration of the set of components of the wireless device (e.g., device 902 may transmit indication 982 to UE 904); or storing the indication of the configuration of the set of components of the wireless device (e.g., device 902 may store indication 984 in memory 906).

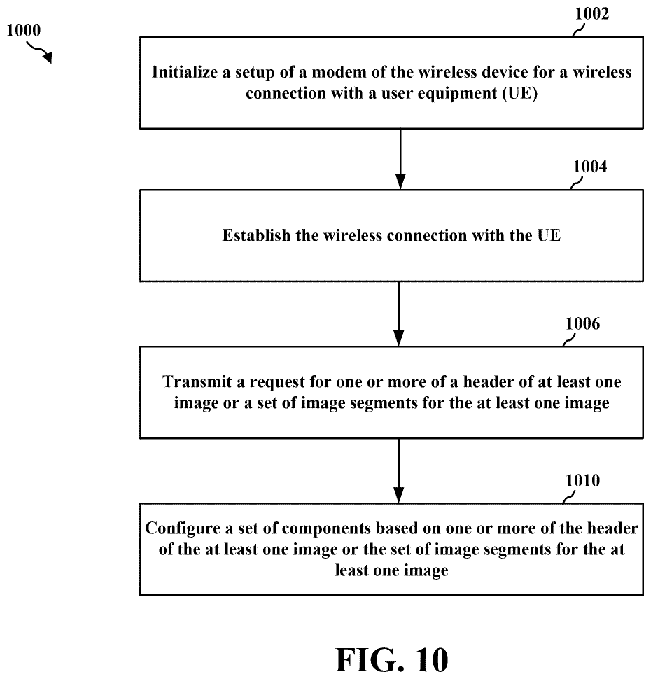

FIG. 10 is a flowchart 1000 of an example method of image processing in accordance with one or more techniques of this disclosure. The method may be performed by a client device, a headset, HMD, AR glasses, a server, phone, smartphone, a DPU (or other display processor), a CPU (or other central processor), a DPU driver, a DDIC, a GPU (or other graphics processor), an apparatus for display processing, a wireless communication device, and/or any apparatus that may perform frame processing as used in connection with the examples of FIGS. 1-9.

At 1002, the device (e.g., a wireless device) may initialize a setup of a modem of the device for a wireless connection with a user equipment (UE), as described in connection with the examples in FIGS. 1-9. For example, as described in 910 of FIG. 9, device 902 may initialize a setup of a modem of the device for a wireless connection with a user equipment (UE). Further, step 1002 may be performed by component 198 in FIG. 1. In some aspects, initializing the setup of the modem of the wireless device may comprise: booting the setup of the modem from a non-volatile (NV) memory. The wireless connection may be at least one of: a wireless personal network (WPN) connection, an ultra-wide band (UWB) connection, a Bluetooth connection, a Bluetooth low energy (BLE) connection, or a Wi-Fi connection. Also, the wireless device may be at least one of a headset, a head mounted device (HMD), a glass, a digital glass, or a wearable device.

At 1004, the device (e.g., a wireless device) may establish the wireless connection with the UE, as described in connection with the examples in FIGS. 1-9. For example, as described in 920 of FIG. 9, device 902 may establish the wireless connection with the UE. Further, step 1004 may be performed by component 198 in FIG. 1. In some aspects, establishing the wireless connection with the UE may comprise transmitting, to the UE, a request to establish the wireless connection with the UE; and receiving, from the UE, a confirmation to establish the wireless connection with the UE, where the confirmation is at least one of: an acknowledgement (ACK), a heartbeat, a beacon, a response, or an indication of a synchronization timer.

At 1006, the device (e.g., a wireless device) may transmit, to the UE, a request for one or more of a header of at least one image or a set of image segments for the at least one image, as described in connection with the examples in FIGS. 1-9. For example, as described in 930 of FIG. 9, device 902 may transmit, to the UE, a request for one or more of a header of at least one image or a set of image segments for the at least one image. Further, step 1006 may be performed by component 198 in FIG. 1. In some aspects, the header of the at least one image may comprise at least one of: an amount of the set of image segments, a size of each of the set of image segments, an offset for each of the set of image segments, or a starting address for each of the set of image segments. Also, each of the set of image segments may comprise at least one of: data for the at least one image or a set of instructions for the at least one image.

At 1010, the device (e.g., a wireless device) may configure a set of components of the wireless device based on one or more of the header of the at least one image or the set of image segments for the at least one image, as described in connection with the examples in FIGS. 1-9. For example, as described in 950 of FIG. 9, device 902 may configure a set of components of the wireless device based on one or more of the header of the at least one image or the set of image segments for the at least one image. Further, step 1010 may be performed by component 198 in FIG. 1. In some aspects, the set of components of the wireless device may comprise: a set of hardware components of the wireless device or a set of application-specific integrated circuit (ASIC) hardware components of the wireless device. Also, the set of hardware components of the wireless device may comprise at least one of: an audio-visual (AV) decoder, an AV encoder, a pose estimate component, a data stream compressor component, a set of AV output components, a set of AV input components, a sensor hub, an accelerometer sensor, a gyroscope sensor, a temperature sensor, or a health sensor.

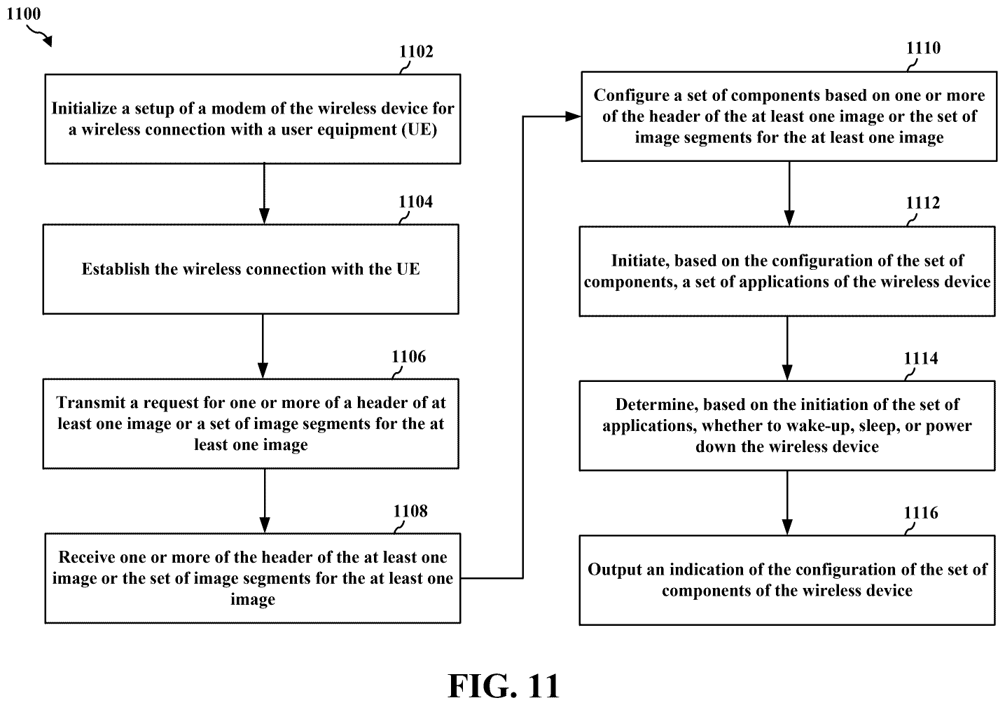

FIG. 11 is a flowchart 1100 of an example method of image processing in accordance with one or more techniques of this disclosure. The method may be performed by a client device, a headset, HMD, AR glasses, a server, phone, smartphone, a DPU (or other display processor), a CPU (or other central processor), a DPU driver, a DDIC, a GPU (or other graphics processor), an apparatus for display processing, a wireless communication device, and/or any apparatus that may perform frame processing as used in connection with the examples of FIGS. 1-9.

At 1102, the device (e.g., a wireless device) may initialize a setup of a modem of the device for a wireless connection with a user equipment (UE), as described in connection with the examples in FIGS. 1-9. For example, as described in 910 of FIG. 9, device 902 may initialize a setup of a modem of the device for a wireless connection with a user equipment (UE). Further, step 1102 may be performed by component 198 in FIG. 1. In some aspects, initializing the setup of the modem of the wireless device may comprise: booting the setup of the modem from a non-volatile (NV) memory. The wireless connection may be at least one of: a wireless personal network (WPN) connection, an ultra-wide band (UWB) connection, a Bluetooth connection, a Bluetooth low energy (BLE) connection, or a Wi-Fi connection. Also, the wireless device may be at least one of a headset, a head mounted device (HMD), a glass, a digital glass, or a wearable device.

At 1104, the device (e.g., a wireless device) may establish the wireless connection with the UE, as described in connection with the examples in FIGS. 1-9. For example, as described in 920 of FIG. 9, device 902 may establish the wireless connection with the UE. Further, step 1104 may be performed by component 198 in FIG. 1. In some aspects, establishing the wireless connection with the UE may comprise transmitting, to the UE, a request to establish the wireless connection with the UE; and receiving, from the UE, a confirmation to establish the wireless connection with the UE, where the confirmation is at least one of: an acknowledgement (ACK), a heartbeat, a beacon, a response, or an indication of a synchronization timer.

At 1106, the device (e.g., a wireless device) may transmit, to the UE, a request for one or more of a header of at least one image or a set of image segments for the at least one image, as described in connection with the examples in FIGS. 1-9. For example, as described in 930 of FIG. 9, device 902 may transmit, to the UE, a request for one or more of a header of at least one image or a set of image segments for the at least one image. Further, step 1106 may be performed by component 198 in FIG. 1. In some aspects, the header of the at least one image may comprise at least one of: an amount of the set of image segments, a size of each of the set of image segments, an offset for each of the set of image segments, or a starting address for each of the set of image segments. Also, each of the set of image segments may comprise at least one of: data for the at least one image or a set of instructions for the at least one image.

At 1108, the device (e.g., a wireless device) may receive, from the UE, one or more of the header of the at least one image or the set of image segments for the at least one image, as described in connection with the examples in FIGS. 1-9. For example, as described in 940 of FIG. 9, device 902 may receive, from the UE, one or more of the header of the at least one image or the set of image segments for the at least one image. Further, step 1108 may be performed by component 198 in FIG. 1. Also, at 1108, the device (e.g., a wireless device) may store, in memory of the wireless device, one or more of the header of the at least one image or the set of image segments for the at least one image, where the memory of the wireless device is on-chip memory of the wireless device or static random access memory (SRAM) of the wireless device.

At 1110, the device (e.g., a wireless device) may configure a set of components of the wireless device based on one or more of the header of the at least one image or the set of image segments for the at least one image, as described in connection with the examples in FIGS. 1-9. For example, as described in 950 of FIG. 9, device 902 may configure a set of components of the wireless device based on one or more of the header of the at least one image or the set of image segments for the at least one image. Further, step 1110 may be performed by component 198 in FIG. 1. In some aspects, the set of components of the wireless device may comprise: a set of hardware components of the wireless device or a set of application-specific integrated circuit (ASIC) hardware components of the wireless device. Also, the set of hardware components of the wireless device may comprise at least one of: an audio-visual (AV) decoder, an AV encoder, a pose estimate component, a data stream compressor component, a set of AV output components, a set of AV input components, a sensor hub, an accelerometer sensor, a gyroscope sensor, a temperature sensor, or a health sensor.

At 1112, the device (e.g., a wireless device) may initiate, based on the configuration of the set of components, a set of applications of the wireless device, as described in connection with the examples in FIGS. 1-9. For example, as described in 960 of FIG. 9, device 902 may initiate, based on the configuration of the set of components, a set of applications of the wireless device. Further, step 1112 may be performed by component 198 in FIG. 1. In some aspects, initiating the set of applications of the wireless device may comprise transmitting, to the UE, a request for audio-visual (AV) content; receiving the AV content from the UE; and outputting the AV content for the set of applications. Also, receiving the AV content from the UE may comprise receiving the AV content from the UE; and storing, in on-chip memory of the wireless device, the AV content from the UE. Further, outputting the AV content for the set of applications may comprise displaying the AV content for the set of applications; or activating the AV content for the set of applications.

At 1114, the device (e.g., a wireless device) may determine, based on the initiation of the set of applications, whether to wake-up, sleep, or power down the wireless device, as described in connection with the examples in FIGS. 1-9. For example, as described in 970 of FIG. 9, device 902 may determine, based on the initiation of the set of applications, whether to wake-up, sleep, or power down the wireless device. Further, step 1114 may be performed by component 198 in FIG. 1. Also, at 1114, the device (e.g., a wireless device) may initiate, based on the determination, a sleep mode at the wireless device including a partial power down mode of the wireless device based on a set of partial state retention conditions. In some aspects, the set of partial state retention conditions may comprise at least one of: an event hysteresis, a user input motion, or a preset head motion. Further, initiating the partial power down mode at the wireless device may comprise: initiating a power down of a static random access memory (SRAM) at the wireless device. Also, at 1114, the device (e.g., a wireless device) may initiate, based on the determination, a full power down at the wireless device based on at least one of: an event hysteresis, a user input motion, or a preset head motion.

At 1116, the device (e.g., a wireless device) may output an indication of the configuration of the set of components of the wireless device, as described in connection with the examples in FIGS. 1-9. For example, as described in 980 of FIG. 9, device 902 may output an indication of the configuration of the set of components of the wireless device. Further, step 1116 may be performed by component 198 in FIG. 1. In some aspects, outputting the indication of the configuration of the set of components of the wireless device may comprise transmitting the indication of the configuration of the set of components of the wireless device; or storing the indication of the configuration of the set of components of the wireless device.

The subject matter described herein may be implemented to realize one or more benefits or advantages. For instance, the described processing techniques may be used by a client device, a headset, HMD, AR glasses, a server, phone, smartphone, a DPU (or other display processor), a CPU (or other central processor), a DPU driver, a DDIC, a GPU (or other graphics processor), an apparatus for display processing, a wireless communication device, or some other processor that may perform display processing to implement the performance and power adjustment techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize dynamic performance and power adjustment techniques in order to improve memory bandwidth efficiency and/or increase processing speed at a client device, a server, a UE, a GPU, a DPU and/or a CPU.

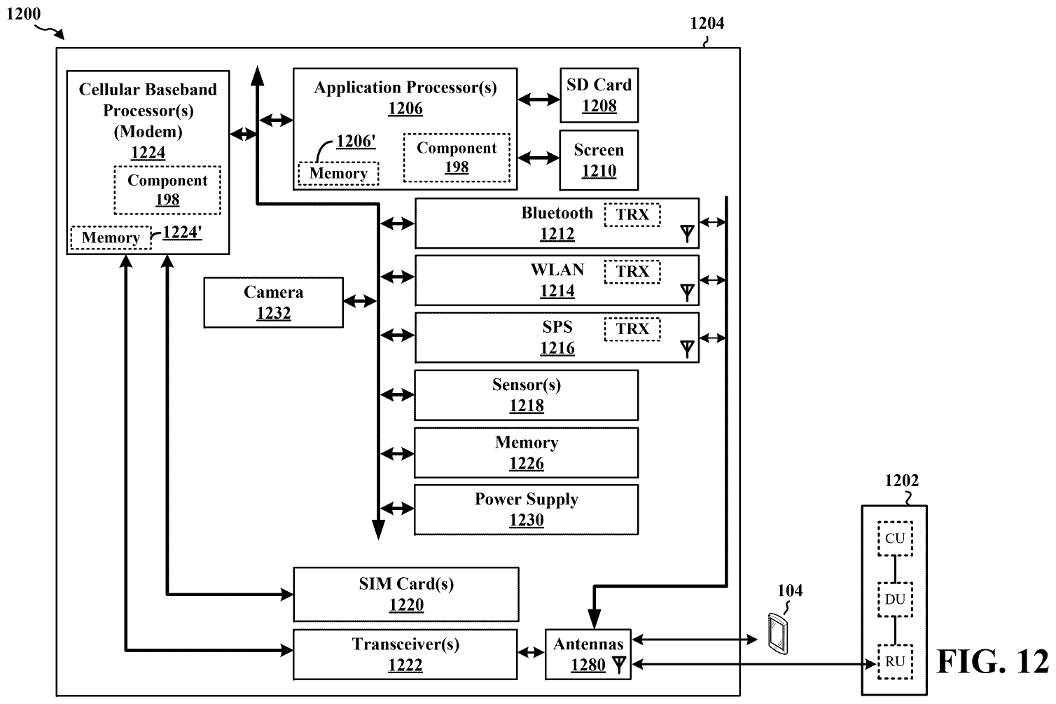

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to initialize a setup of a modem of the wireless device for a wireless connection with a user equipment (UE); establish the wireless connection with the UE; transmit, to the UE, a request for one or more of a header of at least one image or a set of image segments for the at least one image; and configure a set of components of the wireless device based on one or more of the header of the at least one image or the set of image segments for the at least one image. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for initializing a setup of a modem of the wireless device for a wireless connection with a user equipment (UE); means for establishing the wireless connection with the UE; means for transmitting, to the UE, a request for one or more of a header of at least one image or a set of image segments for the at least one image; means for configuring a set of components of the wireless device based on one or more of the header of the at least one image or the set of image segments for the at least one image; means for initiating, based on the configuration of the set of components, a set of applications of the wireless device; means for determining, based on the initiation of the set of applications, whether to wake-up, sleep, or power down the wireless device; means for initiating, based on the determination, a sleep mode at the wireless device including a partial power down mode of the wireless device based on a set of partial state retention conditions; means for initiating, based on the determination, a full power down at the wireless device based on at least one of: an event hysteresis, a user input motion, or a preset head motion; means for receiving, from the UE, one or more of the header of the at least one image or the set of image segments for the at least one image; and means for storing, in memory of the wireless device, one or more of the header of the at least one image or the set of image segments for the at least one image, where the memory of the wireless device is on-chip memory of the wireless device or static random access memory (SRAM) of the wireless device. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for wireless communication at a wireless device, including at least one memory; and at least one processor coupled to the at least one memory and, based at least in part on information stored in the at least one memory, the at least one processor, individually or in any combination, is configured to: initialize a setup of a modem of the wireless device for a wireless connection with a user equipment (UE); establish the wireless connection with the UE; transmit, to the UE, a request for one or more of a header of at least one image or a set of image segments for the at least one image; and configure a set of components of the wireless device based on one or more of the header of the at least one image or the set of image segments for the at least one image.

Aspect 2 is the apparatus of aspect 1, wherein the at least one processor, individually or in any combination, is further configured to: initiate, based on the configuration of the set of components, a set of applications of the wireless device.

Aspect 3 is the apparatus of aspect 2, wherein to initiate the set of applications of the wireless device, the at least one processor, individually or in any combination, is configured to: transmit, to the UE, a request for audio-visual (AV) content; receive the AV content from the UE; and output the AV content for the set of applications.

Aspect 4 is the apparatus of aspect 3, wherein to receive the AV content from the UE, the at least one processor, individually or in any combination, is configured to: receive the AV content from the UE; and store, in on-chip memory of the wireless device, the AV content from the UE.

Aspect 5 is the apparatus of any of aspects 3 to 4, wherein to output the AV content for the set of applications, the at least one processor, individually or in any combination, is configured to: display the AV content for the set of applications; or activate the AV content for the set of applications.

Aspect 6 is the apparatus of any of aspects 2 to 5, wherein the at least one processor, individually or in any combination, is further configured to: determine, based on the initiation of the set of applications, whether to wake-up, sleep, or power down the wireless device.

Aspect 7 is the apparatus of aspect 6, wherein the at least one processor, individually or in any combination, is further configured to: initiate, based on the determination, a sleep mode at the wireless device including a partial power down mode of the wireless device based on a set of partial state retention conditions.

Aspect 8 is the apparatus of aspect 7, wherein the set of partial state retention conditions comprises at least one of: an event hysteresis, a user input motion, or a preset head motion; and wherein to initiate the partial power down mode at the wireless device, the at least one processor, individually or in any combination, is configured to: initiate a power down of a static random access memory (SRAM) at the wireless device.

Aspect 9 is the apparatus of any of aspects 6 to 8, wherein the at least one processor, individually or in any combination, is further configured to: initiate, based on the determination, a full power down at the wireless device based on at least one of: an event hysteresis, a user input motion, or a preset head motion.

Aspect 10 is the apparatus of any of aspects 1 to 9, wherein the header of the at least one image comprises at least one of: an amount of the set of image segments, a size of each of the set of image segments, an offset for each of the set of image segments, or a starting address for each of the set of image segments; and wherein each of the set of image segments comprises at least one of: data for the at least one image or a set of instructions for the at least one image.

Aspect 11 is the apparatus of any of aspects 1 to 10, wherein the set of components of the wireless device comprises: a set of hardware components of the wireless device or a set of application-specific integrated circuit (ASIC) hardware components of the wireless device; and wherein the set of hardware components of the wireless device comprises at least one of: an audio-visual (AV) decoder, an AV encoder, a pose estimate component, a data stream compressor component, a set of AV output components, a set of AV input components, a sensor hub, an accelerometer sensor, a gyroscope sensor, a temperature sensor, or a health sensor.

Aspect 12 is the apparatus of any of aspects 1 to 11, wherein the at least one processor, individually or in any combination, is further configured to: receive, from the UE, one or more of the header of the at least one image or the set of image segments for the at least one image.

Aspect 13 is the apparatus of aspect 12, wherein the at least one processor, individually or in any combination, is further configured to: store, in memory of the wireless device, one or more of the header of the at least one image or the set of image segments for the at least one image, wherein the memory of the wireless device is on-chip memory of the wireless device or static random access memory (SRAM) of the wireless device.

Aspect 14 is the apparatus of any of aspects 1 to 13, wherein to initialize the setup of the modem of the wireless device, the at least one processor, individually or in any combination, is configured to: boot the setup of the modem from a non-volatile (NV) memory.

Aspect 15 is the apparatus of any of aspects 1 to 14, wherein to establish the wireless connection with the UE, the at least one processor, individually or in any combination, is configured to: transmit, to the UE, a request to establish the wireless connection with the UE; and receive, from the UE, a confirmation to establish the wireless connection with the UE, wherein the confirmation is at least one of: an acknowledgement (ACK), a heartbeat, a beacon, a response, or an indication of a synchronization timer.

Aspect 16 is the apparatus of any of aspects 1 to 15, wherein the wireless connection is at least one of: a wireless personal network (WPN) connection, an ultra-wide band (UWB) connection, a Bluetooth connection, a Bluetooth low energy (BLE) connection, or a Wi-Fi connection; and wherein the wireless device is at least one of a headset, a head mounted device (HMD), a glass, a digital glass, or a wearable device.

Aspect 17 is the apparatus of any of aspects 1 to 16, wherein the at least one processor, individually or in any combination, is further configured to: output an indication of the configuration of the set of components of the wireless device.

Aspect 18 is the apparatus of aspect 17, wherein to output the indication of the configuration of the set of components of the wireless device, the at least one processor, individually or in any combination, is configured to: transmit the indication of the configuration of the set of components of the wireless device; or store the indication of the configuration of the set of components of the wireless device.

Aspect 19 is the apparatus of aspect 18, further comprising at least one of an antenna or a transceiver coupled to the at least one processor, wherein to transmit the indication of the configuration of the set of components of the wireless device, the at least one processor, individually or in any combination, is configured to: transmit, via at least one of the antenna or the transceiver, the indication of the configuration of the set of components of the wireless device.

Aspect 20 is a method of wireless communication for implementing any of aspects 1 to 19.

Aspect 21 is an apparatus for wireless communication including means for implementing any of aspects 1 to 19.

Aspect 22 is a computer-readable medium (e.g., a non-transitory computer-readable medium) storing computer executable code, the code when executed by at least one processor causes the at least one processor to implement any of aspects 1 to 19.

What is claimed is:

1. An apparatus for wireless communication at a wireless device, comprising:
at least one memory; and
at least one processor coupled to the at least one memory and, based at least in part on information stored in the at least one memory, the at least one processor, individually or in any combination, is configured to:
initialize a setup of a modem of the wireless device for a wireless connection with a user equipment (UE);
establish the wireless connection with the UE;
transmit, to the UE, a request for one or more of a header of at least one image or a set of image segments for the at least one image; and
configure a set of components of the wireless device based on one or more of the header of the at least one image or the set of image segments for the at least one image.

2. The apparatus of claim 1, wherein the at least one processor, individually or in any combination, is further configured to:
initiate, based on the configuration of the set of components, a set of applications of the wireless device.

3. The apparatus of claim 2, wherein to initiate the set of applications of the wireless device, the at least one processor, individually or in any combination, is configured to:
transmit, to the UE, a request for audio-visual (AV) content;
receive the AV content from the UE; and
output the AV content for the set of applications.

4. The apparatus of claim 3, wherein to receive the AV content from the UE, the at least one processor, individually or in any combination, is configured to:
receive the AV content from the UE; and
store, in on-chip memory of the wireless device, the AV content from the UE.

5. The apparatus of claim 3, wherein to output the AV content for the set of applications, the at least one processor, individually or in any combination, is configured to:
display the AV content for the set of applications; or
activate the AV content for the set of applications.

6. The apparatus of claim 2, wherein the at least one processor, individually or in any combination, is further configured to:
determine, based on the initiation of the set of applications, whether to wake-up, sleep, or power down the wireless device.

7. The apparatus of claim 6, wherein the at least one processor, individually or in any combination, is further configured to:
initiate, based on the determination, a sleep mode at the wireless device including a partial power down mode of the wireless device based on a set of partial state retention conditions.

8. The apparatus of claim 7, wherein the set of partial state retention conditions comprises at least one of: an event hysteresis, a user input motion, or a preset head motion; and
wherein to initiate the partial power down mode at the wireless device, the at least one processor, individually or in any combination, is configured to: initiate a power down of a static random access memory (SRAM) at the wireless device.

9. The apparatus of claim 6, wherein the at least one processor, individually or in any combination, is further configured to:
initiate, based on the determination, a full power down at the wireless device based on at least one of: an event hysteresis, a user input motion, or a preset head motion.

10. The apparatus of claim 1, wherein the header of the at least one image comprises at least one of: an amount of the set of image segments, a size of each of the set of image segments, an offset for each of the set of image segments, or a starting address for each of the set of image segments; and
wherein each of the set of image segments comprises at least one of: data for the at least one image or a set of instructions for the at least one image.

11. The apparatus of claim 1, wherein the set of components of the wireless device comprises: a set of hardware components of the wireless device or a set of application-specific integrated circuit (ASIC) hardware components of the wireless device; and
wherein the set of hardware components of the wireless device comprises at least one of: an audio-visual (AV) decoder, an AV encoder, a pose estimate component, a data stream compressor component, a set of AV output components, a set of AV input components, a sensor hub, an accelerometer sensor, a gyroscope sensor, a temperature sensor, or a health sensor.

12. The apparatus of claim 1, wherein the at least one processor, individually or in any combination, is further configured to:
receive, from the UE, one or more of the header of the at least one image or the set of image segments for the at least one image.

13. The apparatus of claim 12, wherein the at least one processor, individually or in any combination, is further configured to:
store, in memory of the wireless device, one or more of the header of the at least one image or the set of image segments for the at least one image, wherein the memory of the wireless device is on-chip memory of the wireless device or static random access memory (SRAM) of the wireless device.

14. The apparatus of claim 1, wherein to initialize the setup of the modem of the wireless device, the at least one processor, individually or in any combination, is configured to: boot the setup of the modem from a non-volatile (NV) memory.

15. The apparatus of claim 1, wherein to establish the wireless connection with the UE, the at least one processor, individually or in any combination, is configured to:
transmit, to the UE, a request to establish the wireless connection with the UE; and
receive, from the UE, a confirmation to establish the wireless connection with the UE, wherein the confirmation is at least one of: an acknowledgement (ACK), a heartbeat, a beacon, a response, or an indication of a synchronization timer.

16. The apparatus of claim 1, wherein the wireless connection is at least one of: a wireless personal network (WPN) connection, an ultra-wide band (UWB) connection, a Bluetooth connection, a Bluetooth low energy (BLE) connection, or a Wi-Fi connection; and
wherein the wireless device is at least one of a headset, a head mounted device (HMD), a glass, a digital glass, or a wearable device.

17. The apparatus of claim 1, wherein the at least one processor, individually or in any combination, is further configured to:
output an indication of the configuration of the set of components of the wireless device.

18. The apparatus of claim 17, further comprising at least one of an antenna or a transceiver coupled to the at least one processor, wherein to output the indication of the configuration of the set of components of the wireless device, the at least one processor, individually or in any combination, is configured to:
transmit, via at least one of the antenna or the transceiver, the indication of the configuration of the set of components of the wireless device; or
store the indication of the configuration of the set of components of the wireless device.

19. A method of wireless communication at a wireless device, comprising:
initializing a setup of a modem of the wireless device for a wireless connection with a user equipment (UE);
establishing the wireless connection with the UE;
transmitting, to the UE, a request for one or more of a header of at least one image or a set of image segments for the at least one image; and
configuring a set of components of the wireless device based on one or more of the header of the at least one image or the set of image segments for the at least one image.

20. A computer-readable medium storing computer executable code for wireless communication at a wireless device, the code when executed by at least one processor causes the at least one processor to:
initialize a setup of a modem of the wireless device for a wireless connection with a user equipment (UE);
establish the wireless connection with the UE;
transmit, to the UE, a request for one or more of a header of at least one image or a set of image segments for the at least one image; and
configure a set of components of the wireless device based on one or more of the header of the at least one image or the set of image segments for the at least one image.
